(19) United States
(12) Patent Application Publication
(10) Pub. No.: US 2013/0343709 A1
(43) Pub. Date: Dec. 26, 2013

(54) FERRULE ASSEMBLIES EMPLOYING MECHANICAL INTERFACES FOR OPTICAL FIBERS, AND RELATED COMPONENTS AND METHODS

(71) Applicants: Jeffrey Dean Danley, Hickory, NC (US); Robert Bruce Elkins, II, Hickory, NC (US); Darrin Max Miller, Hickory, NC (US)

(72) Inventors: Jeffrey Dean Danley, Hickory, NC (US); Robert Bruce Elkins, II, Hickory, NC (US); Darrin Max Miller, Hickory, NC (US)

(21) Appl. No.: 13/769,535

(22) Filed: Feb. 18, 2013

Related U.S. Application Data
(60) Provisional application No. 61/663,199, filed on Jun. 22, 2012.

(51) Int. Cl. G02B 6/36; B23P 11/02

(52) U.S. Cl. CPC G02B 6/36; B23P 11/025
USPC 385/81; 29/428; 29/447

(57) ABSTRACT

Embodiments disclosed herein include ferrule assemblies employing mechanical interfaces for optical fibers and related component and methods. The ferrule assemblies may be used in fiber optic connectors to precisely position the optical fiber relative to the ferrule to facilitate an optical connection with another optical device. In certain embodiments disclosed herein, the ferrule assemblies include a ferrule that includes an inner surface forming a ferrule bore. Each of the ferrules may also include an end portion of an optical fiber disposed in the ferrule bore. The inner surface of the ferrule bore abuts against an outer surface of the optical fiber to form a mechanical interface. In this manner, the mechanical interface secures the optical fiber within the ferrule bore and precisely positioned relative to the ferrule. This mechanical interface may eliminate the need for epoxy or other means to secure the optical fiber within the ferrule bore.

### RELATED APPLICATIONS

This application claims the benefit of priority under 35 U.S.C. §119 of U.S. Provisional Application Ser. No. 61/663,199 filed on Jun. 22, 2012, the content of which is relied upon and incorporated herein by reference in its entirety.

### BACKGROUND

1. Field of the Disclosure

The technology of the disclosure relates to securing optical fibers in ferrules as part of fiber optic connector assemblies used to establish fiber optic connections.

2. Technical Background

Benefits of optical fibers include extremely wide bandwidth and low noise operation. In cases where high bandwidth is required between two interconnection locations, fiber optic cables having fiber optic connectors may be used to communicate information between these locations. The fiber optic connectors also may be used to conveniently connect and disconnect the fiber optic cables from the interconnect locations when maintenance and upgrades occur.

Each of the fiber optic connectors may include a ferrule assembly having a ferrule. The ferrule has several purposes. The ferrule includes an internal pathway, called a ferrule bore, through which an optical fiber is supported and protected. The ferrule bore also includes an opening at an end face of the ferrule. The opening is where an optical surface of an end portion of the optical fiber may be located to be aligned to an end portion of another optical fiber of a complementary connector. The end portions need to be aligned to establish an optical connection.

The optical surface of the optical fiber is designed for a fixed spatial relationship to the end face of the ferrule. The optical surface facilitates light transmission and/or reception to and from the fiber optic cable. Efficient and accurate transmitting and receiving light between the optical surfaces of adjacent optical fibers of the fiber optic connector and the complementary fiber optic connector, respectively, is critical to minimize signal attenuation. In this regard, the optical fiber should not move relative to the ferrule or the spatial relationship of the optical surface of the optical fiber from the end face of the ferrule would not be precisely located. Precision is required, because the optical fiber extends from the end face of the ferrule towards another optical surface of the optical fiber of the complementary optical connector. When the spatial relationship is precisely achieved, the optical surface of the optical fiber will exactly press against the optical surface of the other optical fiber of the complementary fiber optic connector to minimize the air gap therebetween, for example, consistent with International Standard CEI/IEC 61755-3-2. Air gaps between the optical surfaces can increase attenuation.

In this regard, a thermosetting epoxy (“epoxy”) is typically utilized to bond the optical fiber to the ferrule bore, so the optical fiber is secured within the ferrule bore. Epoxy may be less desirable because of fundamental mechanical properties, an inefficient and difficult application process, and significant manufacturing waste. The fundamental mechanical properties of epoxy cause problems for fiber optic connector performance. The ferrule and the optical fiber bond may be required to function consistently over tens of thousands of cycles of optical connections and disconnections with complementary optical connectors as networks are upgraded and maintained over the life of the optical connector. The mechanical properties of epoxy are plastic wherein the optical fiber generally increasingly moves over time when subjected to mechanical and thermal loading. The spatial relationship of the optical fiber within the ferrule is difficult to predict with certainty, because epoxy is difficult to apply uniformly to all ferrule assemblies.

Applying epoxy during manufacturing can be inefficient and difficult. The epoxy may be incorrectly applied to the ferrule and optical fiber during manufacturing. Specifically, epoxy is typically applied within the ferrule manually through a syringe. The epoxy flows from the syringe and is difficult to direct to the designated location between the ferrule and the optical fiber. An incomplete bond may be formed between the optical fiber and the ferrule when not enough epoxy flows to the designated location. The incomplete bond may allow movement to occur and thereby change the spatial relationship between the optical fiber and the ferrule and cause attenuation. Epoxy may also inadvertently flow from the syringe to other areas of the fiber optic connector causing defects. For example, the epoxy may flow to a spring connected to a ferrule holder body which needs to move within an inner housing unfettered by epoxy. A relatively expensive epoxy-resistant part, for example, a Teflon lead-in tube, is added to the fiber optic connectors to contain the epoxy and prevent epoxy flow to other areas of the fiber optic connector. Epoxy may also develop air bubbles or voids and so the ferrule and optical fiber may need to be placed in a time-consuming vacuum environment to remove these voids or air bubbles. To detect defects related from epoxy, labor-intensive inspection procedures can be conducted as part of the manufacturing process. The numerous additional manufacturing steps needed to support the application of epoxy to the ferrule make the manufacture of a ferrule assembly inefficient.

Also, applying epoxy as part of assembling a ferrule assembly may create significant manufacturing waste. Epoxy is made up of an epoxide resin (“resin”) and a polyamine hardener (“hardener”). The resin and hardener are mixed together before being introduced into the ferrule. Shipments of resin and hardener often arrive at the assembly area at irregular frequencies and may have a shelf life of six (6) months to a year. As an example, characteristics of the epoxy change during the six (6) months and so unused epoxy is discarded after a six (6) month period has elapsed, causing in some cases significant manufacturing waste. Further, once mixed, the epoxy must be used within a time window or discarded causing even further waste. The time window may be generally only extended to, for example, up to eight (8) hours when the mixed epoxy is chilled.

A process and assembly are desired to secure the optical fiber from moving with respect to the ferrule that is more efficient to manufacture and creates less waste.

### SUMMARY OF THE DETAILED DESCRIPTION

Embodiments disclosed herein include ferrule assemblies employing mechanical interfaces for optical fibers and related component and methods. The ferrule assemblies may be used in fiber optic connectors to precisely position the optical fiber relative to the ferrule to facilitate an optical connection with another optical device. In certain embodiments disclosed herein, the ferrule assemblies include a ferrule that includes an inner surface forming a ferrule bore. Each of the ferrules also includes an end portion of an optical fiber disposed in the ferrule bore. The inner surface of the ferrule bore abuts against an outer surface of the optical fiber to form a mechanical interface. In this manner, the mechanical interface secures the optical fiber within the ferrule bore and precisely positions the optical fiber relative to the ferrule. This mechanical interface may eliminate the need for epoxy or other means to secure the optical fiber within the ferrule bore.

In another embodiment, a method of assembling a ferrule assembly for a fiber optic connector is provided. The method includes providing a ferrule including an inner surface forming a ferrule bore. The method also includes disposing an end portion of the optical fiber in the ferrule bore. The method also includes forming a mechanical interface by abutting the inner surface of the ferrule bore against an outer surface of the optical fiber. The mechanical interface secures the end portion of the optical fiber within the ferrule bore. In this manner, the optical fiber is secured within the ferrule bore and thereby precisely positioned relative to the ferrule.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a side cross-sectional view of an exemplary fiber optic connector that includes a ferrule assembly including an optical fiber of a fiber optic cable secured within a ferrule by a mechanical interface provided within a ferrule bore;

FIGS. 2A and 2B are perspective and front views, respectively, of the ferrule of FIG. 1;

FIG. 3A is a side view of the fiber optic cable of FIG. 1, including an optical fiber disposed within an outer jacket of the fiber optic cable and an end portion of the optical fiber, stripped, and extending from a transition interface and prepared to be disposed in the ferrule bore;

FIGS. 3B and 3C are cross-sectional views of the fiber optic cable of FIG. 3A through a stripped and unstripped portion of the fiber optic cable, respectively;

FIG. 4 is a flowchart diagram of an exemplary process of inserting an optical fiber into the ferrule bore as part of assembling a first exemplary ferrule assembly of the fiber optic connector of FIG. 1;

FIG. 5A is a cutaway view along an optical axis A₁ of the ferrule of FIG. 2A adjacent to the optical fiber of FIG. 3A, and according to the exemplary process of FIG. 4;

FIG. 5B is a cutaway view along the optical axis A₁ of the ferrule of FIG. 5A adjacent to the optical fiber of FIG. 3A, with the ferrule being heated according to the exemplary process of FIG. 4;

FIG. 5C is a cutaway view along the optical axis A₁ of the ferrule of FIG. 5B adjacent to the optical fiber of FIG. 5B, with the optical fiber being disposed within the ferrule and the ferrule at a threshold temperature according to the exemplary process of FIG. 4;

FIG. 5D is a cutaway view along the optical axis A₁ of the ferrule of FIG. 5B with the optical fiber of FIG. 5B secured by a mechanical interface within the ferrule according to the exemplary process of FIG. 4;

FIG. 6 is a flowchart diagram of another exemplary process of inserting an optical fiber into the ferrule bore as part of assembling a second exemplary ferrule assembly of the fiber optic connector of FIG. 1;

FIG. 7A is a cutaway view along an optical axis A₁ of the ferrule of FIG. 2A adjacent to an optical fiber including a primary coating according to the exemplary process of FIG. 6;

FIG. 7B is a cross-sectional view orthogonal to the optical axis A₁ of the optical fiber of FIG. 7A including the primary coating according to the exemplary process of FIG. 6;

FIG. 7C is a cutaway view along the optical axis A₁ of the ferrule of FIG. 7A adjacent to the optical fiber of FIG. 7A, with the ferrule being heated according to the exemplary process of FIG. 6;

FIG. 7D is a cutaway view along the optical axis A₁ of the ferrule of FIG. 7C adjacent to the optical fiber of FIG. 7C, with the optical fiber being disposed within the ferrule and the ferrule at a threshold temperature according to the exemplary process of FIG. 6;

FIG. 7E is a cutaway view along the optical axis A₁ of the ferrule of FIG. 7D with the optical fiber of FIG. 7D secured by a mechanical interface within the ferrule according to the exemplary process of FIG. 6;

FIG. 8 is a flowchart diagram of another exemplary process of inserting an optical fiber into the ferrule bore as part of assembling a third exemplary ferrule assembly of the fiber optic connector of FIG. 1;

FIG. 9A is a cutaway view along an optical axis A₁ of the ferrule of FIG. 2A adjacent to an optical fiber having a primary coating, according to the exemplary process of FIG. 8;

FIG. 9B is a cross-sectional view orthogonal to the optical axis A₁ of the optical fiber of FIG. 9A including the primary coating;

FIG. 9C is a cutaway view along the optical axis A₁ of the ferrule of FIG. 9A adjacent to the optical fiber of FIG. 9A, wherein the ferrule may be heated according to the exemplary process of FIG. 8;

FIG. 9D is a cutaway view along the optical axis A₁ of the ferrule of FIG. 9C adjacent to the optical fiber of FIG. 9C, with the optical fiber being disposed within the ferrule and the ferrule at a threshold temperature according to the exemplary process of FIG. 8;

FIG. 9E is a cutaway view along the optical axis A₁ of the ferrule of FIG. 9D with the optical fiber of FIG. 9D secured by a mechanical interface within the ferrule according to the exemplary process of FIG. 8;

FIG. 10A is a fourth exemplary ferrule assembly including the optical fiber of FIG. 3A and the ferrule of FIG. 2A; with silicone disposed between the ferrule and optical fiber;

FIG. 10B is a graph showing a force F_{I} of the mechanical interface versus position along the optical axis of the ferrule assembly of FIG. 10A;

FIG. 11A is a fifth exemplary ferrule assembly including the optical fiber of FIG. 3A and a second exemplary ferrule;

FIG. 11B is a graph showing a force F_{I} of the mechanical interface versus position along the optical axis of the ferrule assembly of FIG. 11A;

FIG. 12A is a sixth exemplary ferrule assembly including the optical fiber of FIG. 3A and a third exemplary ferrule; and

FIG. 12B is a graph showing a force F_{I} of the mechanical interface versus position along the optical axis of the ferrule assembly of FIG. 12A.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include ferrule assemblies employing mechanical interfaces for optical fibers and related component and methods. The ferrule assemblies may be used in fiber optic connectors to precisely position the optical fiber relative to the ferrule to facilitate an optical connection with another optical device. In certain embodiments disclosed herein, the ferrule assemblies include a ferrule that includes an inner surface forming a ferrule bore. Each of the ferrules also includes an end portion of an optical fiber disposed in the ferrule bore. The inner surface of the ferrule bore abuts against an outer surface of the optical fiber to form a mechanical interface. In this manner, the mechanical interface secures the optical fiber within the ferrule bore and precisely positioned relative to the ferrule. This mechanical interface may eliminate the need for epoxy or other means to secure the optical fiber within the ferrule bore.

In this regard, FIG. 1 illustrates a fiber optic connector 10 that includes a ferrule assembly employing a mechanical interface for an optical fiber. As illustrated in FIG. 1, the fiber optic connector 10 has an optical fiber 12 that includes an optical surface 14 for mating to another optical fiber (not shown) in a mated fiber optic connector or adapter. The fiber optic connector 10 includes a ferrule assembly 15 including the optical fiber 12 and a ferrule 16(1). The ferrule 16(1) laterally and angularly aligns an end portion 18 of the optical fiber 12 at an end face 20 of the ferrule 16(1). The ferrule 16(1) includes a first end 22, a second end 24, and a ferrule bore 26 (“microbore”) extending between the first end 22 and the second end 24.

The ferrule 16(1) includes an inner surface 27 forming the ferrule bore 26 and connecting the first end 22 of the ferrule 16(1) to the second end 24. The end portion 18 of the optical fiber 12 is disposed in the ferrule bore 26 and extends to the end face 20 on the second end 24 of the ferrule 16(1). An opening 29 of the end face 20 of the ferrule 16(1) may enable the optical fiber 12 to exit the ferrule bore 26 and extend through the end face 20 so that the end portion 18 of the optical fiber 12 may be located at the end face 20 of the ferrule 16(1) for convenient optical coupling with the complementary receptacle. An optical axis A₁ may be disposed through a center of the ferrule bore 26.

The optical axis A₁ extends from the first end 22 to the second end 24 of the ferrule 16(1). The optical axis A₁ may coincide with the ferrule bore 26, because the optical fiber 12 may be received through the ferrule bore 26.

The optical fiber 12 is secured within the ferrule bore 26 with a mechanical interface 30 in this embodiment as opposed to use of epoxy as a non-limiting embodiment. The inner surface 27 of the ferrule bore 26 may abut against an outer surface 31 of the optical fiber 12 to form the mechanical interface 30. The mechanical interface 30 secures the optical fiber 12 within the ferrule bore 26. The mechanical interface 30 may be free from a bonding agent, for example, epoxy. In this manner, no epoxy may be disposed between the inner surface 27 of the ferrule bore 26 and the outer surface 31 of the optical fiber 12. The mechanical interface 30 may prevent movement of the optical fiber 12 within the ferrule bore 26 to minimize signal attenuation between the optical fiber 12 and the complementary receptacle (not shown), which may include an opposing optical fiber.

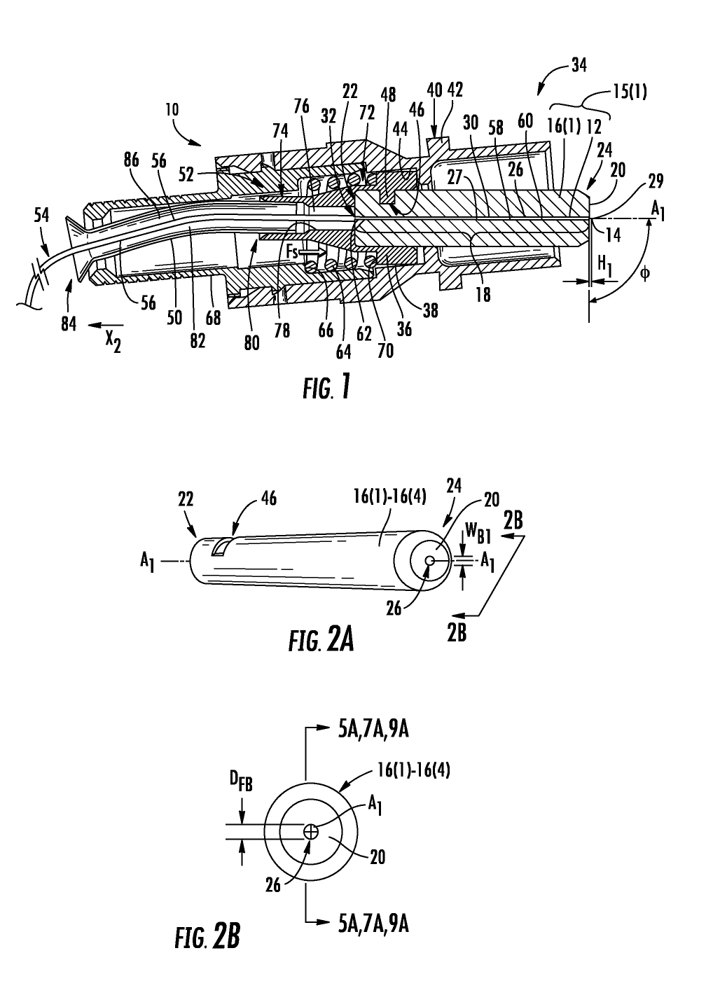

As will be discussed by example in more detail below, the mechanical interface 30 may be configured to allow the optical fiber 12 to enter or depart the ferrule bore 26 when a temperature of the ferrule 16(1) is at least a threshold temperature, for example, one-hundred (100) degrees Celsius. The mechanical interface 30 may be a thermal clamp operated by changes in temperature of the ferrule 16(1) which changes dimensions of the inner surface 27 of the ferrule bore 26 relative to the outer surface 31 of the optical fiber 12. A thermal expansion coefficient of the ferrule 16(1) may be at least fifteen (15) times as large as a thermal expansion coefficient of the optical fiber 12. In this manner, a minimum bore width W_{B1} (FIG. 2A) of the ferrule bore 26 may increase at least fifteen (15) times as fast as a maximum fiber width W_{OF} of the outer surface 31 of the optical fiber 12 as the ferrule 16(1) is heated. When the temperature of the ferrule 16(1) reaches the threshold temperature, then the optical fiber 12 may be inserted into the ferrule bore 26 of the ferrule 16(1). When the temperature of the ferrule 16(1) is reduced to ninety-five (95) degrees Celsius or below, then the mechanical interface 30 is configured to secure the end portion 18 of the optical fiber 12 within the ferrule bore 26. The ninety-five (95) degrees Celsius temperature may provide sufficient margin above an expected temperature operating range of the fiber optic connector 10. It is noted that the maximum fiber width W_{OF} of the optical fiber 12 may be greater than the minimum bore width W_{B1} of the ferrule bore 26 when the ferrule 16(1) and the optical fiber 12 are detached and less than or equal to ninety-five (95) degrees Celsius.

With continuing reference to FIG. 1, the end face 20 of the ferrule 16(1) may be butted against a complementary receptacle (not shown), which may include, for example, another ferrule, under pressure to provide the lowest attenuation of light passing between the end portion 18 of the optical fiber 12 and the complementary receptacle. The ferrule 16(1) may be made of a rigid material that may be manufactured to tight tolerances. One example of such rigid material is a ceramic material, for example, zirconium dioxide (ZrO₂). As discussed above, the ferrule 16(1) may receive, support, and position the end portion 18 of the optical fiber 12.

With continuing reference to FIG. 1, the end face 20 may be orthogonal to the optical axis A₁ or may be angled at angle φ (phi) with respect to the optical axis A₁. The angle φ (phi) may be, for example, within ten (10) degrees of orthogonal with respect to the optical axis as depicted in FIG. 1. The angle φ (phi) may be angled to be non-orthogonal to suppress optical reflection at the optical surface 14.

An entry opening 32 may be disposed at the first end 22 of the ferrule 16(1). The entry opening 32 may provide the passageway by which the optical fiber 12 enters the ferrule bore 26 of the ferrule 16(1). The entry opening 32 may be cone-shaped to provide easy entry of the optical fiber 12 into the ferrule bore 26.

With continuing reference to FIG. 1, the ferrule 16(1) may be disposed at a front end 34 of the fiber optic connector 10. The first end 22 of the ferrule 16(1) may be at least partially disposed within a ferrule holder body 36. The ferrule holder body 36 supports the ferrule 16(1) within the fiber optic connector 10. The ferrule holder body 36 may include a body alignment surface 38 which may be disposed to allow easy insertion of the ferrule holder body 36 within a housing 40 of the fiber optic connector 10. In the non-limiting examples used herein, the housing 40 may be, for example, an inner housing 42 including a housing alignment surface 44. The second end 24 of the ferrule 16(1) may be at least partially disposed within the inner housing 42. In this regard, the ferrule 16(1) may be better protected from random perturbation forces (“side loads”) orthogonal to the optical axis A₁ when unmated to the complementary receptacle (not shown).

It is noted that the ferrule holder body 36 in FIG. 1 may also be used in other fiber optic connectors, including but not limited to a spring-loaded ferrule holder body 36 without the inner housing 42, for example, non-SC type fiber optic connectors. In these other fiber optic connectors, the housing may be an enclosure (not shown) around the ferrule holder body 36. It is also noted that the ferrule 16(1) may include a ferrule notch 46. A portion 48 of the ferrule holder body 36 may be disposed within the ferrule notch 46 to prevent the ferrule 16(1) from disengaging from the ferrule holder body 36. The ferrule holder body 36 may comprise, for example, molded plastic.

The ferrule 16(1) includes more features than can be observed in FIG. 1. In this regard, FIGS. 2A and 2B depict the ferrule 16(1) shown in FIG. 1 in a perspective and front view, respectively. The ferrule notch 46 may be a recess in the ferrule 16(1). The ferrule notch 46 may be separated from the ferrule bore 26 which is shown with the maximum fiber width W_{B1} in FIG. 2B. In this manner, the portion 48 may not obstruct the ferrule bore 26 and thereby prevent passage of the optical fiber 12 during assembly of the ferrule assembly 15.

With reference back to FIG. 1, the fiber optic connector 10 may also include a lead-in tube 50 engaged to a rear end 52 of the ferrule holder body 36 to align the optical fiber 12. Specifically, the lead-in tube 50 facilitates guiding the end portion 18 of the optical fiber 12 into the ferrule holder body 36, where the optical fiber 12 can then be guided to the ferrule 16(1). The lead-in tube 50 may also prevent sharp bends from occurring in the optical fiber 12 during insertion that could damage the optical fiber 12 as the optical fiber 12 is disposed in the ferrule holder body 36 and into the ferrule 16(1).

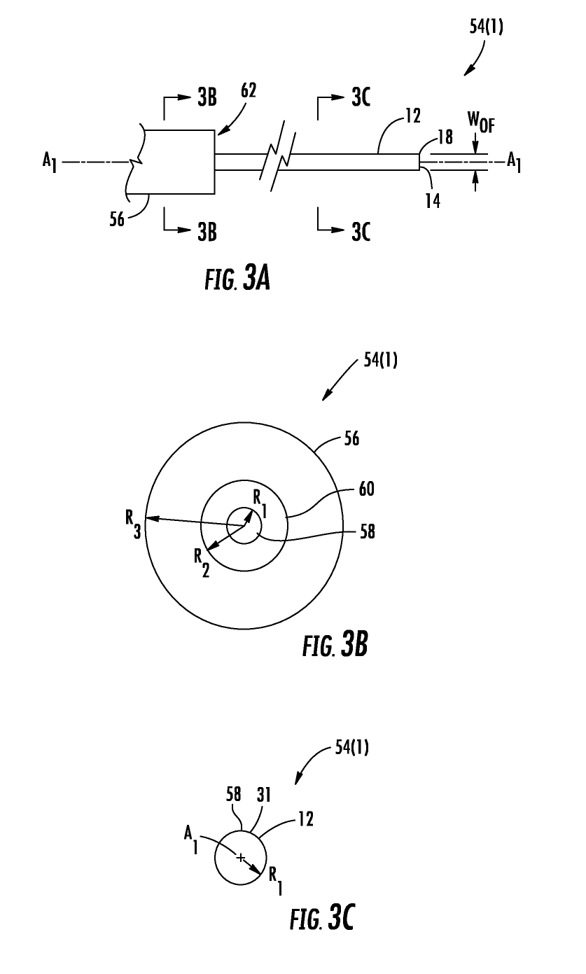

The optical fiber 12 includes more features than can be observed in FIG. 1. In this regard, FIGS. 3A through 3C illustrate a side view and two cross-sectional views, respectively, of a fiber optic cable 54(1). The optical fiber 12 may be part of a fiber optic cable 54(1) which may be used in the fiber optic connector 10 of FIG. 1. The fiber optic cable 54(1) and optical fiber 12 include broken lines in FIG. 3A to show indeterminate length. The fiber optic cable 54(1) may be a single fiber drop cable, and the ferrule 16(1) may be a single fiber ferrule, although the use of other types of drop cables, optical fibers connector types, and/or ferrules are possible. The fiber optic cable 54(1) may include an outer jacket 56 to surround and protect the outer surface 31 of the optical fiber 12. The optical fiber 12 may comprise, for example, a silicon dioxide (SiO₂) material. The outer jacket 56 may comprise a strong flexible material, for example, a polyurethane acrylate resin commercially available from DSM Desotech Inc. of Elgin, Ill.

The optical fiber 12 may include a bare optical fiber 58 and a primary coating 60. The primary coating 60 may surround the bare optical fiber 58 and may prevent surface abrasions from forming on the bare optical fiber 58 during manufacturing and while in the fiber optic connector 10. Surface abrasions may be created when the bare optical fiber 58 contacts other objects. The surface abrasions may weaken the bare optical fibers 58 and thereby damage or break the bare optical fibers 58. The primary coating 60 prevents surface abrasions from being created and thereby protect the bare optical fiber 58. The primary coating 60 may comprise a strong flexible material, for example, ultra-violet (UV) curable acrylate.

The outer jacket 56 of the fiber optic cable 54 may be partially stripped from the end portion 18 up to a transition interface 62, as shown in FIG. 3A, to expose the optical fiber 12 before insertion of the end portion 18 into the ferrule 16(1). In some embodiments none, some, or an entire amount of the primary coating 60 may be removed from the end portion 18 up to the transition interface 62. FIG. 3C depicts the optical fiber 12 comprising the bare optical fiber 58 where the primary coating 60 may be removed up to the transition interface 62. When the optical fiber 12 is fully inserted and secured by the mechanical interface 30, the transition interface 62 may be disposed just outside the first end 22 of the ferrule 16(1) (FIG. 1) so that the optical fiber 12 may be protected by the outer jacket 56 outside the ferrule 16(1).

With reference back to FIG. 1, there are also features to press the optical fiber 12 forward to facilitate the formation of an optical connection with a complimentary receptacle. A spring 64 may be disposed between a spring seat base 66 of a crimp body 68 attached to the inner housing 42 and a spring seating surface 70 of the ferrule holder body 36. The spring 64 may be biased to apply a spring force F_{S} to the spring seating surface 70 to push the ferrule holder body 36 and thereby push the end face 20 of the ferrule 16(1) against the complementary receptacle. With contact between the end face 20 and the complementary receptacle, the ferrule holder body 36 may translate in the rear direction X₂ and the spring force F_{S} will press the end face 20, including the end portion 18 of the optical fiber 12, against the complementary receptacle to minimize attenuation.

Details of the fiber optic connector 10 have been introduced employing the ferrule 16(1) having the end portion 18 of the optical fiber extending through the end face 20 of the ferrule 16(1). The relationship of the ferrule 16(1) to the insertion of the optical fiber 12 into the ferrule 16(1) and ferrule holder body 36 will now be discussed in relation to a fiber optic connector 10. In this regard, the fiber optic connector 10 may form the final critical passageway travelled by the end portion 18 of the optical fiber 12 to the end face 20. The ferrule holder body 36 may comprise a front end 72 opposite a rear end 74 along the optical axis A₁. The ferrule holder body 36 may include an internal passage 76 formed by an inner body surface 78 extending from the front end 72 to the rear end 74 along the optical axis A₁ to thereby align the end portion 18 of the optical fiber 12 to the ferrule bore 26. The lead-in tube 50 may include a front end 80 integrated with the rear end 74 of the ferrule holder body 36. The lead-in tube 50 may include a lead-in bore 82 extending in the optical axis A₁ from a rear end 84 of the lead-in tube 50 to the front end 80 of the lead-in tube 50. An inner lead-in surface 86 may form the lead-in bore 82 of the lead-in tube 50. The inner lead-in surface 86 may guide the optical fiber 12 thorough the lead-in bore 82 and into the internal passage 76 of the ferrule holder body 36.

The lead-in tube 50 may be made of a flexible and resilient material with high surface lubricity, for example, polyethylene, silicone, or thermoplastic elastomer. This material may also include additives, for example, mineral fill or silica-based lubricant or graphite. In this manner, the optical fiber 12 may smoothly travel the lead-in bore 82 without being caught during insertion.

The ferrule holder body 36 may be made of a relatively strong material, for example, metal or plastic. The ferrule holder body 36 may be made with all junctions and edges of the internal passage 76 chamfered or otherwise smoothly transitioned from one inside diameter to the next to provide surfaces to the optical fiber 12 without sharp edges for the optical fiber 12 to catch or be damaged during insertion.

The front end 80 of the lead-in tube 50 may be configured to receive and guide the end portion 18 of the optical fiber 12 along the optical axis A₁ through the rear end 74 of the ferrule holder body 36 and into the internal passage 76 of the ferrule holder body 36. The lead-in bore 82 of the lead-in tube 50 and the internal passage 76 of the ferrule holder body 36 enables the end portion 18 of the optical fiber 12 to reach the first end 22 of the ferrule 16(1) with a protected and aligned position before continuing through the ferrule bore 26 to the end face 20. The end portion 18 of the optical fiber 12 may exit the ferrule bore 26 through the opening 29 after traveling from the first end 22 to the second end 24 of the ferrule 16(1). After exiting the opening 29, the end portion 18 may extend a height H₁ past the end face 20 of the ferrule 16(1). The optical fiber 12 may then be secured by the mechanical interface 30. The height H₁ may be, for example, more than five-hundred (500) nanometers (nm) and may be further reduced with material removal operations, for example polishing, to form the optical surface 14 of the end portion 18 of the optical fiber 12.

The optical surface 14 of the optical fiber 12 is disposed at a position relative to the end face 20 of the ferrule 16(1) to provide a pathway for optical transmission and/or reception. Efficient and accurate transmitting and receiving of light between the optical surfaces 14 of the adjacent optical fibers 12 of the fiber optic connector 10 and the complementary receptacle, respectively, may be critical to minimize signal attenuation. In this regard, the optical surface 14 of the optical fiber 12 should be created to be free of optical defects. Secondly, the position of the optical surface 14 of the optical fiber 12 relative to the end face 20 of the ferrule 16(1) may be accurately achieved and secured by the mechanical interface 30. Accuracy of the position is required, because the optical fiber 12 extends from the ferrule bore 26 of the ferrule 16(1) to exactly press against the optical surface 14′ of the other optical fiber 12′ of the complementary receptacle during an optical connection to minimize the air gap therebetween, for example, consistent with International Standard CEI/IEC 61755-3-2. Air gaps between the optical surfaces causes attenuation and should be avoided; thus keeping the optical fiber 12 secure within the ferrule 16(1) with the mechanical interface 30 may reduce air gaps.

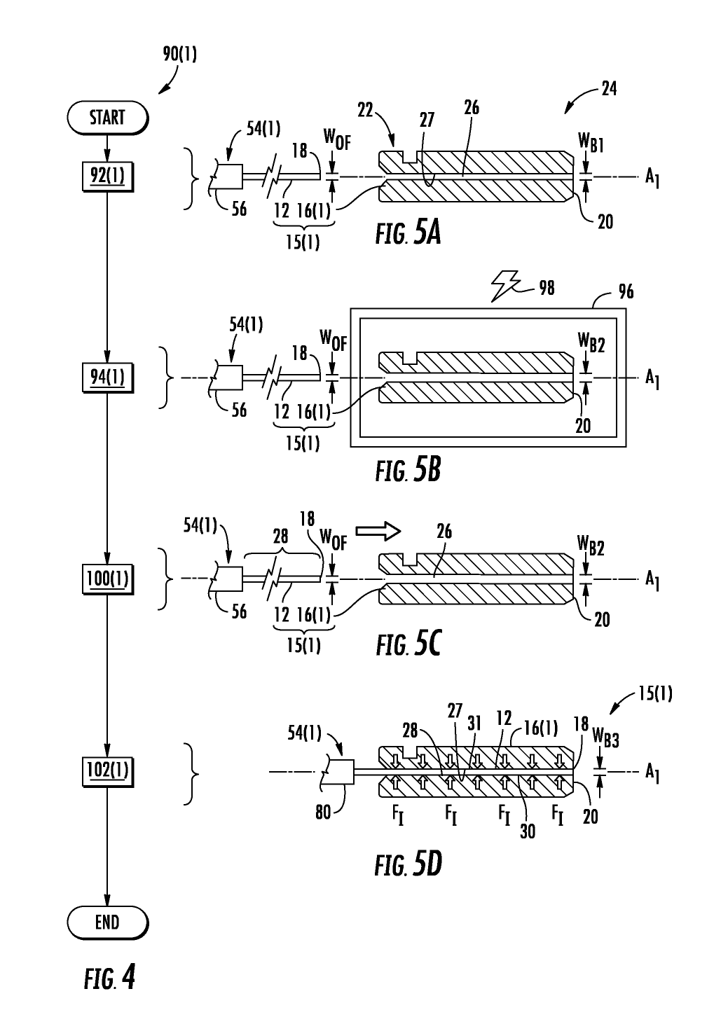

Now that the ferrule assembly 15 has been introduced, exemplary processes 90(1)-90(3) will be introduced in succession for inserting the optical fiber 12 within the ferrule bore 26 as part of assembling the ferrule assembly 15. The ferrule assembly 15 employs the mechanical interface 30 for the optical fiber 12. In this regard, FIG. 4 is a flowchart diagram of the exemplary process 90(1) of assembling the ferrule assembly 15 for the fiber optic connector 10. The process 90(1) in FIG. 4 will be described using terminology and information provided above. FIGS. 5A-5D correspond with steps 92(1), 94(1), 100(1), and 102(1), respectively in FIG. 4, and will be discussed together.

As shown in FIG. 5A, the process 90(1) includes providing the ferrule 16(1) and the optical fiber 12 of the ferrule assembly 15(1) (step 92(1) in FIG. 4). The ferrule 16(1) includes the inner surface 27 forming the ferrule bore 26. The ferrule 16(1) and the optical fiber 12 may be detached and have temperatures less than or equal to ninety-five (95) degrees Celsius where the minimum bore width Wᵢₙ of the ferrule bore 26 may be less than the maximum fiber width W_{OF} of the optical fiber 12.

As depicted in FIG. 5B, the process 90(1) may include heating the ferrule 16(1) above the threshold temperature (step 94(1) in FIG. 4). The ferrule 16(1) may be heated, for example, in an oven 96 powered by electricity 98. As a temperature of the ferrule 16(1) increases to the threshold temperature, the minimum bore width W_{B1} may increase to a minimum bore width W_{B2} which is greater than the maximum fiber width W_{OF} of the optical fiber 12. It is noted that the optical fiber 12 may also be heated to reduce the risk of thermal shock to the ferrule 16(1) or optical fiber 12 when they are later placed in contact. The thermal expansion coefficient of the ferrule 16(1) may be at least fifteen (15) times as large as the thermal expansion coefficient of the optical fiber 12. In this regard, as both the optical fiber 12 and the ferrule 16(1) may be heated, the minimum bore width W_{B2} of the ferrule bore 26 may increase in size faster than the maximum fiber width W_{OF} of the optical fiber 12. It is noted that FIG. 5B depicts only the ferrule 16(1) being heated according to the process 90(1).

FIG. 5C depicts the process 90(1) may include disposing the end portion 18 of the optical fiber 12 in the ferrule bore 26 of the ferrule 16(1) (step 100(1) in FIG. 4). The minimum bore width W_{B2} of the ferrule bore 26 may be greater than the maximum fiber width W_{OF} of the optical fiber 12, so that the optical fiber 12 may be inserted without damage. The end portion 18 of the optical fiber 12 may be disposed adjacent to the end face 20 of the ferrule 16(1).

FIG. 5D depicts the process 90(1) including forming the mechanical interface 30 between the inner surface 27 of the ferrule 16(1) and the outer surface 31 of the optical fiber 12 to secure the end portion 18 of the optical fiber 12 within the ferrule bore 26 (step 102(1) in FIG. 4). The ferrule 16(1) and the optical fiber 12 may be cooled to less than or equal to ninety-five (95) degrees Celsius. While cooling, a minimum bore width W_{B3} may be reached by the ferrule 16(1) as the ferrule 16(1) constricts around the end portion 18 of the optical fiber 12 causing a force F_{I} to be applied by the ferrule 16(1) upon the optical fiber 12. The force F_{I} may form the mechanical interface 30 to secure the end portion 18 of the optical fiber 12 within the ferrule 16(1) by friction or by an interference fit. The resulting minimum bore width W_{B3} may be greater than the minimum bore width W_{B1} and less than the minimum bore width W_{B2}.

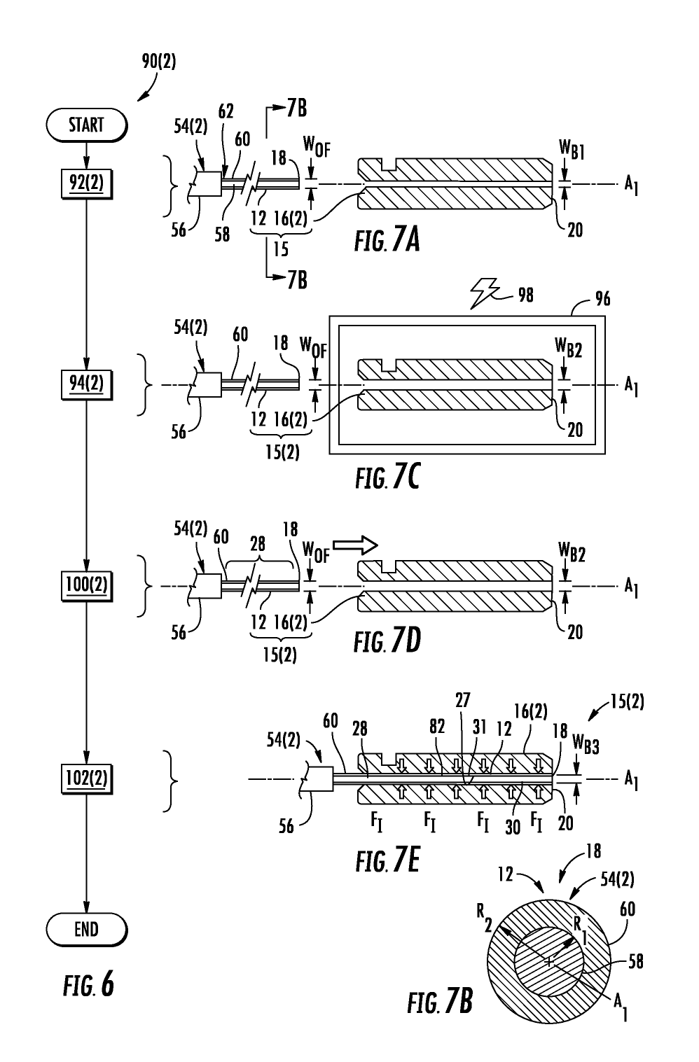

FIG. 6 is a flowchart diagram of an exemplary process 90(2) of assembling a ferrule assembly 15(2) which may be used instead of the ferrule assembly 15(1) in the fiber optic connector 10. The process 90(2) will be described using the terminology and information provided above. Specifically, process 90(2) is similar to the process 90(1) and only the differences between the processes 90(1)-90(2) will be discussed to enhance conciseness and clarity. In this regard, the process 90(2) may include steps 92(2), 94(2), 100(2), and 102(2) of FIG. 6, corresponding with FIGS. 7A, 7C, 7D, and 7E, respectively.

FIG. 7B shows a cross-section view of the optical fiber 12 of FIG. 7A. Unlike the process 90(1), the fiber optic cable 54(2) may be stripped back to the transition interface 62 so that the primary coating 60 may be disposed upon the bare optical fiber 58 of the end portion 18 of the optical fiber 12. In this manner, twice a radius R₂, including a radius R₁ of the bare optical fiber 58, determines the maximum fiber width W_{OF} to form a portion of the mechanical interface 30 with the inner surface 27 of the ferrule bore 26. In this manner, the primary coating 60 may provide additional friction to secure the bare optical fiber 58 to the ferrule 16(2). The primary coating 60 may also provide protection from discontinuities in a material of the ferrule 16(2) and from mechanical damage between the bare optical fiber 58 and the ferrule bore 26.

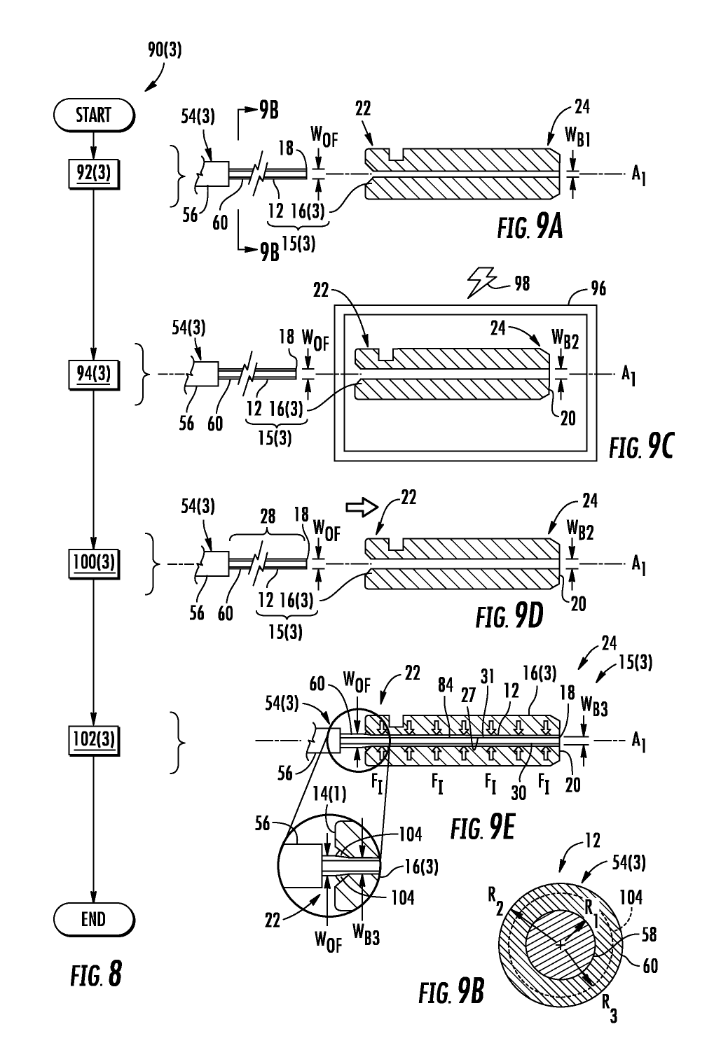

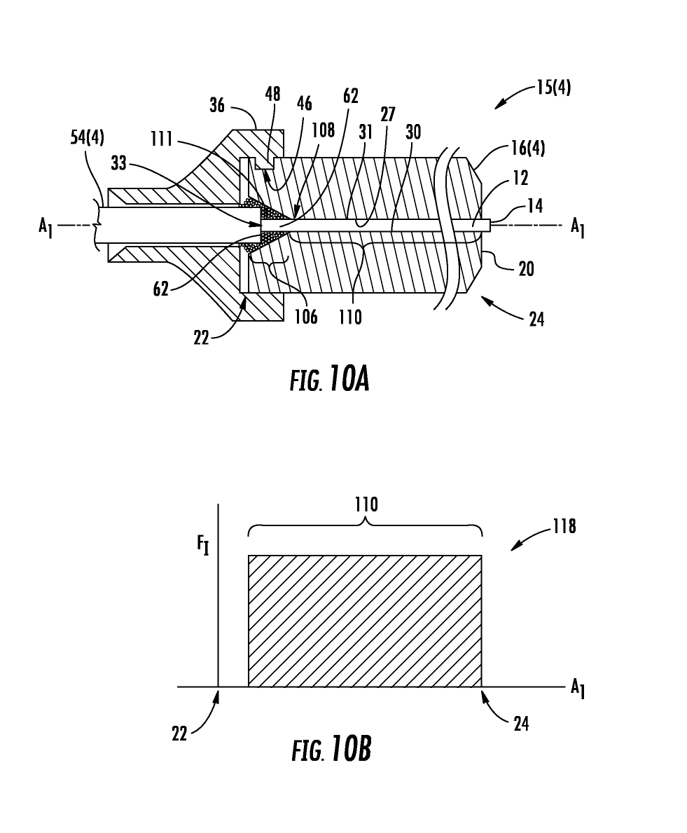

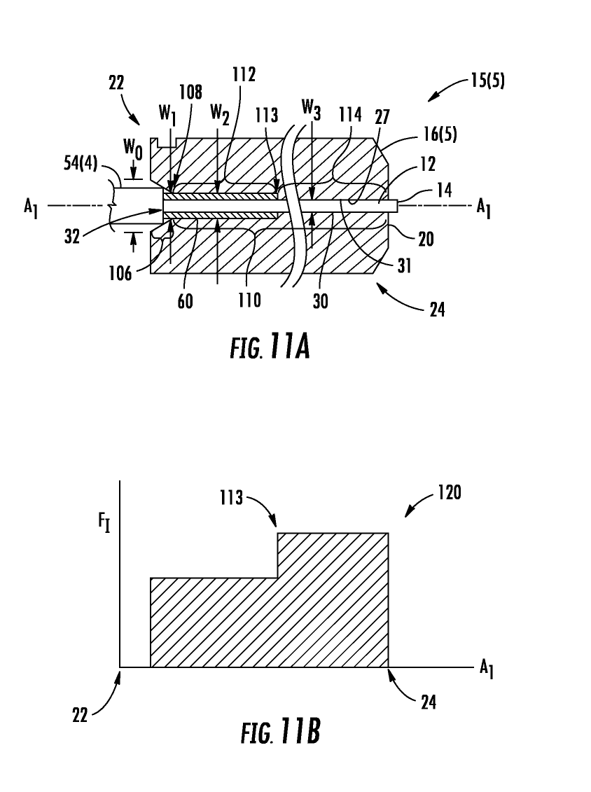

FIG. 8 is a flowchart diagram of an exemplary process 90(3) of assembling a ferrule assembly 15(3) which may be used instead of the ferrule assembly 15(1) in the fiber optic connector 10. The process 90(3) will be described using the terminology and information provided above. Specifically, process 90(3) is similar to process 90(1) and accordingly only the differences between the processes 90(1)-90(3) will be discussed to enhance conciseness and clarity. The process 90(3) may include steps 92(3), 94(3), 100(3) and 102(3) of FIG. 8 and correspond with FIGS. 9A and 9C-9E, respectively.

In this regard, FIG. 9B shows a cross-section of the optical fiber 12 of FIG. 9A. Unlike the process 90(1), but similar to the process 90(2), the fiber optic cable 54(3) may be provided stripped back to the transition interface 62 so that the primary coating 60 may be disposed upon the bare optical fiber 58 of the end portion 18 of the optical fiber 12. In this manner, twice the radius R₂, which includes the radius R₁ of the bare optical fiber 58, may be utilized to determine the maximum fiber width W_{OF} of the optical fiber 12 outside the ferrule 16(3). In process 90(3), twice the radius R₂ is greater than the minimum bore width W_{B2} of the ferrule 16(3) when the ferrule 16(3) is at the threshold temperature. A portion 104 of the primary coating 60 may be outside a radius R₃ of the optical fiber 12 wherein twice the radius R₃ may be equivalent to the minimum bore width W_{B2} of the ferrule 16(3). Accordingly, in FIG. 9D when the end portion 18 of the optical fiber 12 is being disposed in the ferrule bore 26, the portion 104 may be stripped away to accumulate the portion 104 of the primary coating 60 at the first end 22 of the ferrule 16(3) as shown in FIG. 9E. The stripping and accumulation of the portion 104 may be facilitated by the ferrule 16(3) which may be at least the threshold temperature. The accumulation of the portion 104 of the primary coating 60 at the first end 22 of the ferrule 16(3) may protect the optical fiber 12 from forming a sharp bend, which may cause damage to the optical fiber 12 or signal attenuation.

Now that the processes 90(1)-90(3) have been discussed to assemble the ferrule assemblies 15(1)-15(3) for the fiber optic connector 10, ferrule assemblies 15(4)-15(6) are now introduced including ferrules 16(4)-16(5), respectively. The ferrule assemblies 15(4)-15(6) are compatible with the processes 90(1)-90(3) and the mechanical interface 30 to secure the end portion 18 of the optical fiber 12 within the ferrule bore 26. The details of the ferrule bore 26 facilitating the mechanical interface 30 will now be discussed.

In this regard, FIG. 10A depicts a ferrule assembly 15(4) which may replace the ferrule assembly 15(1) in the fiber optic connector 10 of FIG. 1. The inner surface 27 of the ferrule 16(4) may include a first bore transition interface 108 between the first end 22 and the second end 24 of the ferrule 16(4). The inner surface 27 may also include an entry cone 106 extending from the first end 22 to the first bore transition interface 108. The first bore transition interface 108 may connect the entry cone 106 to a first portion 110 of the inner surface 27. The entry cone 106 may have a tapered shape to facilitate the entry of the end portion 18 of the optical fiber 12 into the ferrule bore 26 during assembly. The first portion 110 of the inner surface 27 may include a uniform or substantially uniform width (measured orthogonal to the optical axis A₁) from the second end 24 of the ferrule 16(4) to the first bore transition interface 108. The uniform or substantially uniform width allows for a uniform or substantially uniform force F_{I} to secure the optical fiber 12 with the first portion 110 of the inner surface 27 as shown in a graph 118 in FIG. 10B of force F_{I} versus position along the optical axis A₁ of the ferrule 16(4).

Moreover, the tapered shape of the entry cone 106 may also provide space for the silicone 111 to be disposed in the first end 22 of the ferrule 16(4) between the ferrule 16(4) and the optical fiber 12. The silicone 111 may protect the optical fiber 12 from sharp bends which may damage the optical fiber 12. The mechanical interface 30 may still provide sufficient force F_{I} to secure the optical fiber 12 within the ferrule 16(4) in the presence of the silicone 111.

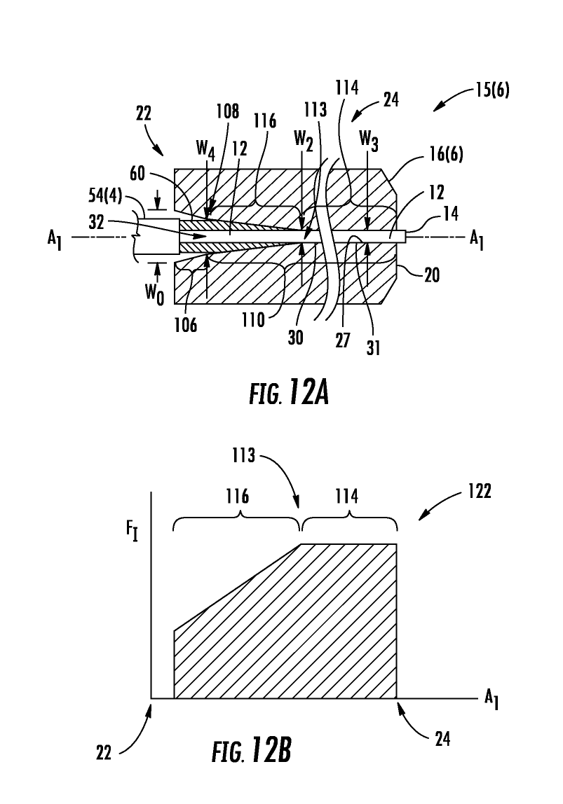

In a different example, FIG. 11A depicts a ferrule assembly 15(5) having a ferrule 16(5) which may replace the ferrule assembly 15(1) of FIG. 1. The inner surface 27 of the ferrule 16(5) may include a first bore transition interface 108 between the first end 22 and the second end 24 of the ferrule 16. The inner surface 27 may also include an entry cone 106 extending from the first end 22 to the first bore transition interface 108. The first bore transition interface 108 may connect the entry cone 106 to a first portion 110 of the inner surface 27. The entry cone 106 may have a tapered shape to facilitate the entry of the end portion 18 of the optical fiber 12 into the ferrule bore 26 during assembly.

Moreover, the ferrule 16(5) may further include a second bore transition interface 113 between the second end 24 of the ferrule 16(5) and the first bore transition interface 108. The first portion 110 of the inner surface 27 may include an exit portion 114 and a second portion 112. The second bore transition interface 113 may attach the exit portion 114 to the second portion 112. The exit portion 114 comprises a uniform or substantially uniform width from the second end 24 of the ferrule 16(5) to the second bore transition interface 113. The second portion 112 may comprise a uniform or substantially uniform width from the second bore transition interface 113 to the entry cone 106. The uniform or substantially uniform width W₂ of the second portion 112 may be greater than the uniform or substantially uniform width W₃ of the exit portion 114 to thereby increase the force F_{I} closer to the end face 20 of the ferrule 16(5). The increased force F_{I} may thereby better secure the optical fiber 12 adjacent to the end face 20. FIG. 11B depicts the increased force F_{I} in a graph 120 showing force F_{I} versus position along the optical axis A₁ of the ferrule 16(5) of FIG. 11A. It is noted that the primary coating 60 of the outer surface 31 of the optical fiber 12 may abut against the inner surface 27 and create the force F_{I} in the second portion 112.

In a different example, FIG. 12A depicts a ferrule assembly 15(6) having a ferrule 16(6) which may replace the ferrule assembly 15(1) of FIG. 1. The inner surface 27 of the ferrule 16(6) may include a first bore transition interface 108 between the first end 22 and the second end 24 of the ferrule 16(6). The inner surface 27 may also include an entry cone 106 extending from the first end 22 to the first bore transition interface 108. The first bore transition interface 108 may connect the entry cone 106 to a first portion 110 of the inner surface 27. The entry cone 106 may have a tapered shape to facilitate the entry of the end portion 18 of the optical fiber 12 into the ferrule bore 26 during assembly.

Moreover, the ferrule 16(6) may further include the second bore transition interface 113 between the second end 24 of the ferrule 16(6) and the first bore transition interface 108. The first portion 110 of the inner surface 27 may include the exit portion 114 and a third portion 116. The second bore transition interface 113 may attach the exit portion 114 to the third portion 116. The exit portion 114 may comprise the uniform or substantially uniform width from the second end 24 of the ferrule 16(6) to the second bore transition interface 113. The third portion 116 may comprise a second tapered shape from the second bore transition interface 113 to the entry cone 106. The second tapered shape includes a smaller width change than the first tapered shape. The second tapered shape of the third portion 116 allows a gradual increase in the force F_{I} to provide gradual support for the optical fiber 12 along the optical axis A₁ towards the end face 20 of the ferrule 16(6). In this regard, FIG. 12B is a graph 122 showing force F_{I} versus position along the optical axis A₁ of the ferrule 16(6) in FIG. 12A. It is noted that the primary coating 60 of the outer surface 31 of the optical fiber 12 may abut against the inner surface 27 and create the gradual increase in the force F_{I} in the third portion 116.

As used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. Non-limiting examples of bend-insensitive, or bend resistant, optical fibers are ClearCurve® Multimode or single-mode fibers commercially available from Corning Incorporated. Suitable fibers of these types are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. For example, the optical fiber 12 may be cooled or heated while the ferrule 16 is heated to the threshold temperature. Also, for simplicity the processes 90(1)-90(3) and associated FIGS. 5A-5D, 7A-7E, and 9A-9E do not depict components of the fiber optic connector 10, for example, the ferrule holder body 36, the lead-in tube 50, the spring 64, and the inner housing 42. However, some or all these components may be assembled to the ferrule 16 prior to the disposing of the optical fiber 12 in the ferrule 16.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. A ferrule assembly for a fiber optic connector, comprising:
a ferrule including an inner surface forming a ferrule bore; and
an end portion of an optical fiber disposed in the ferrule bore, the inner surface of the ferrule bore abuts against an outer surface of the optical fiber to form a mechanical interface, and the mechanical interface secures the optical fiber within the ferrule bore.

2. The ferrule assembly of claim 1, wherein no epoxy is disposed between the inner surface of the ferrule bore and the outer surface of the optical fiber.

3. The ferrule assembly of claim 1, wherein a coefficient of thermal expansion of the ferrule is larger than a coefficient of thermal expansion of the optical fiber.

4. The ferrule assembly of claim 1, wherein a coefficient of thermal expansion of the ferrule is at least fifteen (15) times as large as a coefficient of thermal expansion of the optical fiber.

5. The ferrule assembly of claim 1, wherein the mechanical interface is configured to secure the optical fiber within the ferrule bore while a temperature of the ferrule and the optical fiber are less than or equal to ninety-five (95) degrees Celsius.

6. The ferrule assembly of claim 1, wherein the mechanical interface is configured to allow the optical fiber to enter or depart the ferrule bore when a temperature difference between the ferrule and the optical fiber is greater than a threshold temperature, wherein the threshold temperature of the ferrule is at least one-hundred (100) degrees Celsius.

7. (canceled)

8. The ferrule assembly of claim 1, wherein a maximum fiber width of the optical fiber is greater than a minimum bore width of the ferrule bore when the ferrule and the optical fiber are detached and less than or equal to ninety-five (95) degrees Celsius.

9. The ferrule assembly of claim 8, wherein the optical fiber further comprises a primary coating, wherein the primary coating of the end portion of the optical fiber abutting the inner surface of the ferrule is thinner than the primary coating outside the ferrule.

10. (canceled)

11. The ferrule assembly of claim 1, wherein the inner surface of the ferrule comprises a first bore transition interface between a first end and a second end of the ferrule, the inner surface of the ferrule also includes an entry cone extending from the first end to the first bore transition interface, the first bore transition interface connects the entry cone to a first portion of the inner surface, the entry cone includes a first tapered shape.

12. The ferrule assembly of claim 11, wherein the first portion of the inner surface comprises a uniform or substantially uniform width from the second end of the ferrule to the first bore transition interface.

13. The ferrule assembly of claim 11, wherein the ferrule further comprises a second bore transition interface between the second end of the ferrule and the first bore transition interface, the first portion of the inner surface includes an exit portion and a second portion, the second bore transition interface attaches the exit portion to the second portion, the exit portion comprises a uniform or substantially uniform width from the second end of the ferrule to the second bore transition interface, and the second portion comprises a second uniform or substantially uniform width from the second bore transition interface to the entry cone, and the second uniform or substantially uniform width of the second portion is greater than the uniform or substantially uniform width of the exit portion.

14. The ferrule assembly of claim 11, wherein the ferrule further comprises a second bore transition interface between the second end of the ferrule and the first bore transition interface, the first portion of the inner surface includes an exit portion and a third portion, the second bore transition interface attaches the exit portion to the second portion, the exit portion comprises a uniform or substantially uniform width from the second end of the ferrule to the second bore transition interface, and the third portion comprises a second tapered shape from the second bore transition interface to the entry cone, and the second tapered shape includes a smaller width change than the first tapered shape.

15. The ferrule assembly of claim 11, further comprising silicone disposed between the ferrule and the optical fiber.

16. A method of assembling a ferrule assembly for a fiber optic connector, comprising:
providing a ferrule of a ferrule assembly including an inner surface forming a ferrule bore;
disposing an end portion of an optical fiber in the ferrule bore; and
forming a mechanical interface by abutting the inner surface of the ferrule bore against an outer surface of the optical fiber, and the mechanical interface secures the end portion of the optical fiber within the ferrule bore.

17. The method of claim 16, wherein the forming the mechanical interface comprises forming an epoxy-free interface.

18. The method of claim 16, wherein the providing the ferrule comprises the ferrule including a coefficient of thermal expansion at least fifteen (15) times as large as a coefficient of thermal expansion of the optical fiber.

19. The method of claim 16, wherein the forming the mechanical interface comprises changing a temperature of the ferrule and a temperature of the optical fiber to less than or equal to ninety-five (95) degrees Celsius.

20. The method of claim 16, further comprising heating the ferrule above a threshold temperature to expand a minimum bore width of the ferrule bore to be larger than a maximum fiber width of the optical fiber, wherein the disposing the end portion of the optical fiber comprises a threshold temperature of at least one-hundred (100) degrees Celsius.

21. (canceled)

22. The method of claim 16, wherein the providing the ferrule comprises a minimum bore width of the ferrule bore less than a maximum fiber width of the optical fiber when the ferrule and the optical fiber are detached and at a temperature less than or equal to ninety-five (95) degrees Celsius.

23. The method of claim 22, wherein the disposing the end portion of the optical fiber in the ferrule bore comprises the end portion of the optical fiber including a primary coating disposed upon a bare optical fiber, wherein the disposing the end portion of the optical fiber in the ferrule bore comprises stripping a portion of the primary coating of the end portion of the optical fiber entering a first end of the ferrule, wherein the stripping the portion of the primary coating includes of the primary mar coating at the first end of the ferrule.

24-26. (canceled)
